(19) United States
(12) Patent Application Publication
(10) Pub. No.: US 2011/0117464 A1
(43) Pub. Date: May 19, 2011

(54) FUEL CELL SYSTEM AND METHOD FOR INFLUENCING THE THERMAL BALANCE OF A FUEL CELL SYSTEM

(75) Inventors: Matthias Boltze, Neuendorf (DE); Michael Rozumek, Neubrandenburg (DE); Stefan Käding, Zerrenthin (DE); Manfred Pfalzgraf, Herrsching (DE); Andreas Engl, Munich (DE); Beate Bleeker, Munich (DE); Michael Süssl, Munich (DE); Markus Bedenbecker, Gauting (DE)

(73) Assignee: ENERDAY GMBH, Stockdorf (DE)

(21) Appl. No.: 12/305,800

(22) PCT Filed: Jun. 5, 2007
(86) PCT No.: PCT/DE2007/001003

§ 371 Date: Dec. 19, 2008

(30) Foreign Application Priority Data
Jul. 10, 2006 (DE) 10 2006 031 866.8

(51) Int. Cl. H01M 8/04

(52) U.S. Cl. 429/434

(57) ABSTRACT

The invention relates to a fuel cells system (10) which comprises at least one heat-generating component (12 to 32) and at least one component (12, 14, 16) that uses process air. The invention is characterized in that ambient air (34) can be supplied to the heat-generating component, said air being heatable by the heat-generating component (12 to 32), and the air heated in said manner being supplied to the component (12, 14, 16) that uses process air. The invention also relates to a method for influencing the thermal balance of the fuel cell system according to the invention.

The invention relates to a fuel cell system comprising at least one component generating heat and at least one component using process air.

The invention relates furthermore to a method for managing the temperature of a fuel cell system.

Fuel cell systems serve to generate electrical energy and thermal energy, it being the primary feed of fossile fuels that is increasingly gaining significance. In the mobile sector, i.e. particularly in motor vehicles preference is given to using the fuels as normal for motor vehicles whilst in the non-mobile sector, i.e. particularly in domestic applications, natural gas and fuel oil are used.

Needed to process these fuels is a reforming process which, at least partly, is strongly exothermic. Likewise finding application are afterburners capable of converting the exhaust gases of the fuel cell or also the primary feed fuel in exothermic reactions. The waste heat generated by the fuel cells themselves in the fuel cell system which, particularly in the case of the solid oxide fuel cell (SOFC), can be quite considerable, need to be taken into account. Thus temperatures ranging from 500 to 1000° C. are involved in the fuel cell system depending on the operating condition and design.

To reduce the heat losses from the fuel cell system due to heat transfer to the environment, components of the fuel cell system are sited within an insulation means. But it is natural that such an insulation means cannot fully prevent heat losses. Apart from this, heat losses may occur particularly in the region of leadthroughs needed especially for supplying or discharging the flow media involving, for instance, fuel feed, air feed or removal, or exhaust gases. The waste heat generated by a DC/DC or an DC/AC converter can be considered as a power loss of the fuel cell system.

This excessive waste heat whilst reducing the efficiency of the system, on the one hand, may also be a nuisance, on the other hand, for instance when operating a fuel cell system for air conditioning on hot days.

The invention is based on the object of providing a fuel cell system having reduced heat losses and an improved temperature management.

This object is achieved by the features of the independent claim.

Advantageous embodiments of the invention read from the dependent claims.

The invention is based on the generic fuel cell system in that the heat generating component can now receive a supply of ambient air for heating by means of the heat generating component and that the thus heated air can be supplied as process air to the component using the process air. Thus, the heat absorbed by the feed of ambient air can now be returned to the system in this way via the chemical and electrochemical processes occurring in the fuel cell system in it thus being recovered.

It is expediently provided for that the heat generating component is accommodated in a housing, to an inner portion of which the ambient air can be supplied. The housing permits accommodating several heat generating components and channeling of the supplied ambient air such that the heat given off by all heat generating components can now contribute towards heating the supplied ambient air.

It is likewise just as possible that a heat generating component is sited outside of a housing in which the further heat generating components are accommodated. For example, it may be expedient to site a DC/DC or a DC/AC converter some distance away from the substantially hotter other components of the fuel cell system. It may thus prove useful not to provide the housing intended for the feed of ambient air for accommodating the converter. If so, applying ambient air to the converter would need to be provided separately, or to do away with making use of the waste heat of the converter.

In another particularly preferred embodiment it may be provided for that the housing is a thermal insulation means which may either be that as provided in any case surrounding heat generating components of the fuel cell system or an additional insulation means surrounding that as provided in any case. In the latter case the air flow is guided between the conventional insulation means and the additional insulation means.

In accordance with another preferred embodiment of the invention it is provided for that the at least one heat generating component is a reformer and/or an afterburner and/or a fuel cell stack and/or a media conduit and/or a DC/DC converter.

It is expediently provided for that the supply of ambient air is fed to the first heat generating components at a first temperature and to subsequent heat generating components at a second temperature, the first temperature being lower than the second temperature. Since the rate of heat transfer depends on the difference in temperature of the media involved, it is usual to first apply colder ambient air to the cooler components to provide a relatively large difference in temperature here too. Air which is already heated can then be supplied to the hotter components, here too a corresponding large difference in temperature existing. In this way all components can be included in managing the temperature of the fuel cell system.

It is particularly useful that the ambient air can be supplied by the delivery of a blower assigned to the component using process air in thus not requiring an additional blower for introducing ambient air into the system.

It may be provided for that the component using process air is a reformer and/or an afterburner and/or a fuel cell stack.

The invention also relates to a method for managing the temperature of a fuel cell system in accordance with the invention.

The invention will now be detailed by way of particularly preferred embodiments with reference to the attached drawings in which:

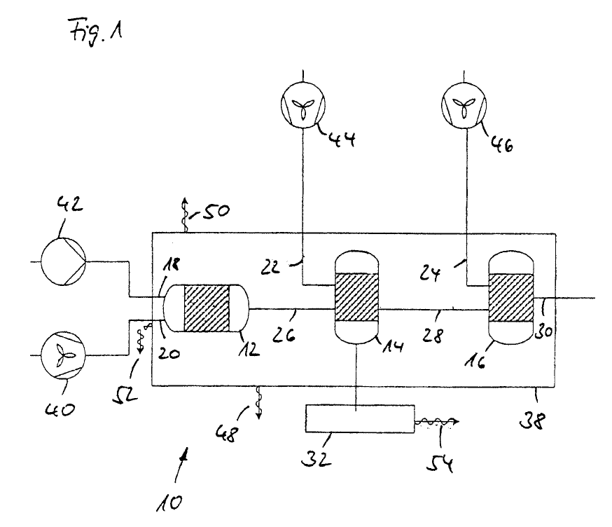

FIG. 1 is a diagrammatic representation of a conventional fuel cell system;

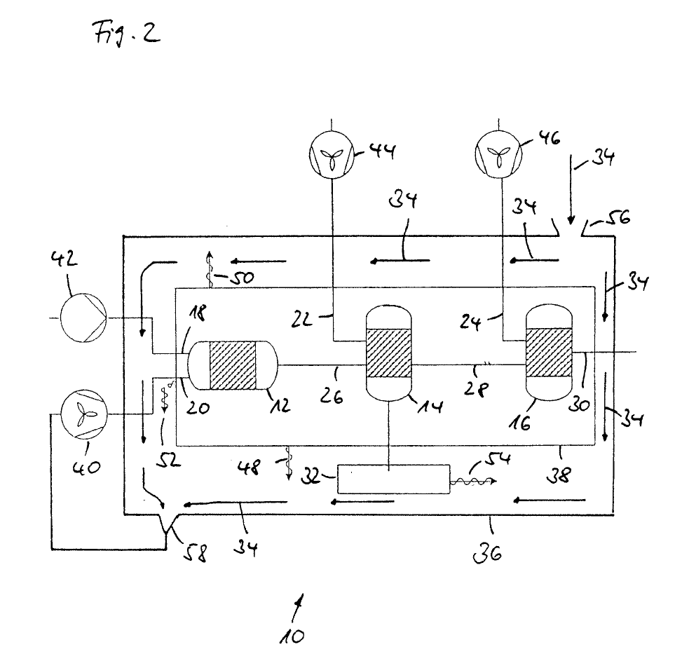

FIG. 2 is a diagrammatic representation of a first embodiment of a fuel cell system in accordance with the invention;

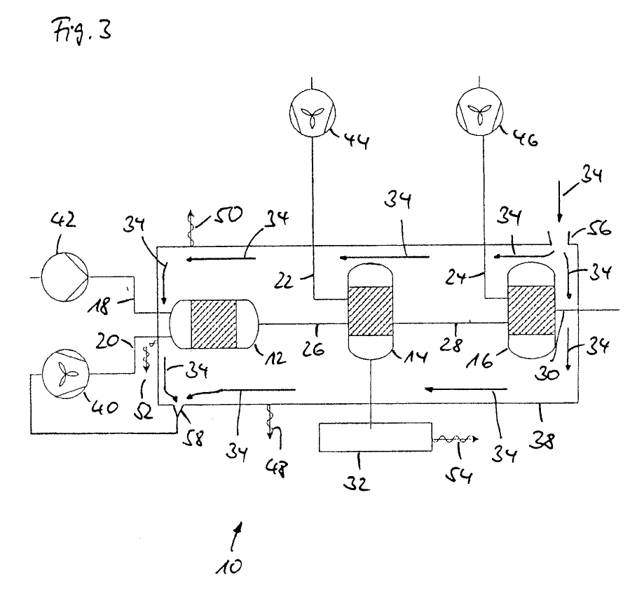

FIG. 3 is a diagrammatic representation of a second embodiment of a fuel cell system in accordance with the invention.

The reference numerals in the following description of the FIGS. in the drawings identify components which are the same or comparable.

Referring now to FIG. 1 there is illustrated a diagrammatic representation of a conventional fuel cell system. This typical fuel cell system 10 comprises a plurality of components sited partly within an insulation means 38. A reformer 12, a fuel cell stack 14 and an afterburner 16 are provided interconnected by the media communicating conduits. Thus, the reformer 12 receives via a fuel feeder 18 a supply of fuel delivered by a fuel pump 42 and air delivered by a blower 40. The hydrogen-rich reformate produced in the reformer 12 gains access via a reformate conduit 26 to the anode end of a fuel cell stack 14, the fuel cell stack 14 receiving furthermore a supply of air via a cathode feed air conduit 22 and an assigned blower 44. Anode exhaust gas of the fuel cell stack 14 is communicated via an anode exhaust gas conduit 28 into an afterburner 16 which likewise receives a supply of air via an air feed conduit 24 and an assigned blower 46. The exhaust gases generated in the afterburner 16 leave the fuel cell system 10 via an exhaust gas conduit 30. The electricity generated by the fuel cell stack 14 is supplied to a converter 32, for example a DC/DC or DC/AC converter. The fuel cell system 10 as described is possible in a wealth of variants in, for instance, exhaust gas being recycled from the afterburner 16, it being likewise possible that air leaving the cathode from the fuel cell stack 14 is supplied to the afterburner 16. It is furthermore possible that heat exchangers are provided achieving an exchange of heat between various media flows, again in a wealth of variants.

Problematic in such fuel cell systems 10 is the loss of heat as is, on the one hand, natural via the insulation means 38 as indicated by the arrows 48, 50 and, on the other, particularly in the region of leadthroughs through the insulation means 38, for example in the region of the media feeders as indicated by arrow 52. Further heat losses occur at the converter 32 indicated by the arrow 54.

Referring now to FIG. 2 there is illustrated a diagrammatic representation of a first embodiment of fuel cell system in accordance with the invention. To counter the problems as explained with reference to FIG. 1 it is proposed to provide a housing 36 featuring at least one air inlet port 56 for entry of ambient air 34. Provided furthermore is an air outlet port 58 coupled to the air entry side of the blower 40. Accommodated in the housing 36 are the heat generating components of the fuel cell system 10. When the blower 40 is in operation, ambient air 34 is drawn into the housing 36 which then envelops the insulation means 38 and the converter 32 sited outside of the insulation means 38 respectively. The cold ambient air 34 entrains the heat and leaves the housing 36 via the air outlet port 58 in the heated condition. Subsequently, the heated ambient air is returned as process air to the reformer 12 via the blower 40. As an alternative or in addition thereto it is likewise just as possible that the heated air is supplied to the fuel cell stack 14 and afterburner 16 respectively.

By means of the aspects as described above, it is now possible to reduce the heat given off by the system as a whole, i.e. the heat emerging from the housing 36 due to the intake ambient air 34 forming so-to-speak a second skin enclosing the insulation means 38 which is continually renewed and the thermal energy communicated by the skin is returned to the fuel cell system 10 via the process air.

Referring now to FIG. 3 there is illustrated a diagrammatic representation of a second embodiment of a fuel cell system in accordance with the invention. In accordance with this example embodiment it is provided for that the insulation means 38 itself features an air inlet port 56 and an air outlet port 58 so that the cool ambient air directly envelops the components, for instance the afterburner 16, the fuel cell stack 14 and the reformer 12 to be returned via the blower 40 to the reformer 12 as process air after leaving in heated condition the air outlet port 58. Designing the system in this way obviates the need for an additional outer housing 36 (see FIG. 2). To likewise return the thermal energy given off by the converter 32 a separate means for returning the hot air would be needed.

It is understood that the features of the invention as disclosed in the above description, in the drawings and as claimed may be essential to achieving the invention both by themselves or in any combination.

### LIST OF REFERENCE NUMERALS

10 fuel cell system
12 reformer
14 fuel cell stack
16 afterburner
18 fuel feeder
20 air feeder
22 cathode feed air conduit
24 feed air conduit
26 reformate conduit
28 anode exhaust gas conduit
30 exhaust gas conduit
32 converter
34 ambient air
36 housing
38 insulation means
40 blower
42 fuel pump
44 blower
46 blower
48 arrow
50 arrow
52 arrow
54 arrow
56 air inlet port
58 air outlet port

1. A fuel cell system comprising at least one component generating heat and at least one component using process air, wherein the heat generating component can receive a supply of ambient air for heating by means of the heat generating component and that the thus heated air can be supplied as process air to the component using the process air.

2. The fuel cell system of claim 1, wherein the heat generating component is accommodated in a housing, to an inner portion of which the ambient air can be supplied.

3. The fuel cell system of claim 1, wherein a heat generating component is sited outside of a housing in which the further heat generating components are accommodated.

4. The fuel cell system of claim 2, wherein the housing is a thermal insulation means.

5. The fuel cell system of claim 1, wherein the at least one heat generating component is a reformer and/or an afterburner and/or a fuel cell stack and/or a media conduit and/or a DC/DC converter.

6. The fuel cell system of claim 1, wherein the supply of ambient air is fed to the first heat generating components at a first temperature and to subsequent heat generating components at a second temperature, the first temperature being lower than the second temperature.

7. The fuel cell system of claim 1, wherein the ambient air can be supplied by the delivery of a blower assigned to the component using process air.

8. The fuel cell system of claim 1, wherein the component using process air is a reformer and/or an afterburner and/or a fuel cell stack.

9. A method for managing the temperature of a fuel cell system of claim 1.
